(19) United States
(12) Patent Application Publication
(10) Pub. No.: US 2019/0227881 A1
(43) Pub. Date: Jul. 25, 2019

(54) CHANGES OF SNAPSHOT INTERVALS

(71) Applicant: Hewlett Packard Enterprise Development LP, Houston, TX (US)

(72) Inventors: Lalatendu Patro, Bangalore (IN); Tushar Vengurlekar, Bangalore (IN)

(21) Appl. No.: 15/878,812

(22) Filed: Jan. 24, 2018

(51) Int. Cl. G06F 11/14

(52) U.S. Cl. CPC G06F 11/1464; G06F 2201/84

(57) ABSTRACT

In example implementations, a method is provided. The method monitors, by a processor, data changes. A measured value of a variable associated with the data changes are detected to exceed a threshold associated with the variable. A snapshot interval is changed to a time interval associated with the variable. Then a snapshot of the memory device is recorded at the time interval.

### BACKGROUND

Enterprises may pay for network storages to store large amounts of data. The storage network may provide memory resources to the enterprise for a subscription fee. The storage network may include a plurality of storage devices that can store data.

The enterprise customers may have a service level agreement (SLA), or other type of contract, to ensure a minimum level of service by the storage network service provider. Storage devices can fail over time and the storage network provider may try to quickly recover the failure for the enterprise customers to meet the SLA.

### BRIEF DESCRIPTION OF THE DRAWINGS

FIG. 1 is a block diagram of an example of an apparatus of the present disclosure;

FIG. 2 is an example graphical representation of snapshot interval changes in response to data changes;

FIG. 3 is a flow chart of an example method for changing a snapshot interval; and

FIG. 4 is a block diagram of an example non-transitory computer readable storage medium storing instructions executed by a processor.

### DETAILED DESCRIPTION

Examples described herein provide a method for controlling snapshot intervals in a storage device. As discussed above, network storage providers may have an SLA with an enterprise customer. If the memory devices in the storage networks fail, the storage network service provider may try to recover the failures as quickly as possible.

One example of recovery is to ensure that all of the data that was stored before the failure is correctly recovered. One method to ensure that the data is properly recovered is to take snapshots of the memory devices at regular intervals. However, if changes to the memory devices occur infrequently, the snapshots at regular intervals may take unnecessary snapshots and consume limited computing resources of the memory device. Conversely, if the changes occur frequently (e.g., many times within a duration of the regular snapshot interval) then the snapshot may not accurately capture the latest contents of the memory device.

The present disclosure provides a control of dynamically changing snapshot intervals. The snapshot intervals may change based on how the data changes are occurring in the memory device. For example, the data changes in the memory device may be monitored and the snapshot interval may be shortened or increased continuously based on the monitoring. As a result, when changes occur frequently, the snapshot intervals may be shortened or when changes occur infrequently, the snapshot intervals may be lengthened.

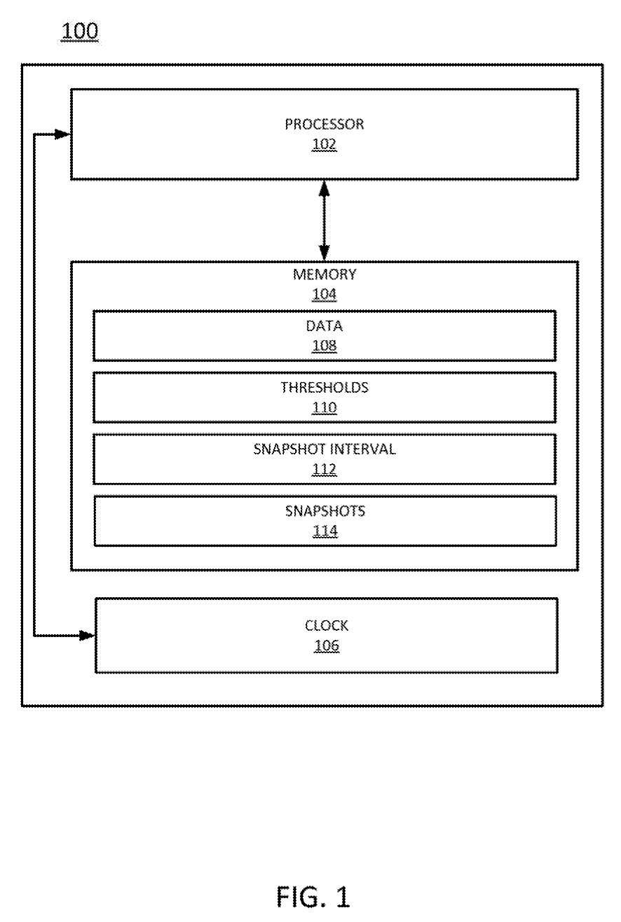

FIG. 1 illustrates an apparatus 100 of the present disclosure. In one example, the apparatus 100 may be a memory or storage device. The apparatus 100 may include a processor 102, a memory 104, and a clock 106. The processor 102 may be communicatively coupled to the memory 104 and the clock 106. In one example, the clock 106 may provide time for the processor 102 to allow the processor 102 to properly time the snapshot intervals discussed in further detail below.

In one example, the memory 104 may be a non-transitory computer readable medium such as a hard disk drive, a random access memory (RAM), a read only memory (ROM), and the like. In one example, the memory 104 may be a combination of different types of memory such as a hard disk drive and RAM. In one example, the memory 104 may be an array of hard disk drives. For example, the apparatus 100 may be a storage server or networked storage device used to store large amounts of data 108.

In one example, the memory 104 may store the data 108. The data 108 may be any type of information that is stored in the memory 104. The memory 104 may also include thresholds 110, a snapshot interval 112 and snapshots 114. The thresholds 110 may be different values for different variables that are measured to change the snapshot interval 112. For example, processor 102 may monitor variables such as a rate of data changes, a volume of data changes, and the like, to determine the snapshot interval 112. For example, the rate of data change variable may be how frequently the data 108 is changed per unit of time. The volume of data change variable may be a total number of data changes for a particular window of time.

The snapshot interval 112 may be a time interval that measures how frequently the snapshots 114 should be captured. The time interval may be measured by the clock 106 and the processor 102 may capture the snapshots 114 for the snapshot interval 112 that is currently selected.

In one example, the snapshot interval 112 may be based on the variables that are monitored. For example, if the rate of data changes exceeds a respective threshold 110, a snapshot interval 112 associated with high rates of data changes may be implemented. In another example, if the volume of data changes exceeds a respective threshold 110, a snapshot interval 112 associated with high volumes of data changes may be implemented. In another example, if none of the respective thresholds 110 are exceeded for any variable, then a predefined time interval may be implemented as the snapshot interval 112.

In one example, the snapshots 114 may comprise a listing of data content stored in the memory 104. In another example, the snapshots 114 may comprise a mirror image of the data 108 stored in the memory 104. In other words, the snapshot 114 that is a mirror image may contain duplicate copies of the data 108. As a result, if a device fails, the data may be recovered using the snapshots 114.

Although FIG. 1 illustrates the data 108, the thresholds 110, the snapshot interval 112, and the snapshots 114 being stored on the same memory, it should be noted that the data 108, the thresholds 110, the snapshot interval 112, and the snapshots 114 may be stored on different portions of the memory 104. As noted above, the memory 104 may be a combination of different types of memory or multiple different hard disk drives. Thus, the snapshots 114 may be stored in RAM, while the data 108, the thresholds 110, and the snapshot interval 112 are stored in a hard disk drive.

In one example, the apparatus 100 may be part of a network of apparatuses 100. For example, the apparatus 100 may be part of a server farm or networked storage devices that provide storage for applications and its services to remotely located customers or clients. In one example, the snapshot interval 112 may be transmitted to a central controller or server of the network. In other words, the snapshots 114 may be stored in a memory that is remotely located from the apparatus 100. For example, the apparatus 100 may have a communication interface to transmit the snapshots 114 via a wired or wireless connection to the central controller or server.

It should be noted that the apparatus 100 in FIG. 1 has been simplified for ease of explanation and may include additional components that are not shown. For example, the apparatus 100 may include communication interfaces to establish a wired or a wireless communication path with other apparatuses 100, client endpoint devices, a centralized controller, and the like.

As noted above, previous storage devices would capture snapshots at regular fixed time intervals. As a result, when no data changes occur, the snapshots may consume unnecessary memory and processing resources. However, when large amounts of data changes occur, the snapshots taken at regular fixed time intervals may not capture an accurate image of the latest data 108 that was stored in the memory 104.

The present disclosure allows the snapshot interval 112 to be dynamically changed based on measured values of particular monitored variables exceeding a respective threshold of the thresholds 110 stored in the memory 104. As noted above, the variables may include a rate of data change, a volume of data change and the like. In one example, “change” may be defined as a write operation on the data 108 or an update request on the data 108.

For example, different variables may be associated with different thresholds 110. When a particular threshold 110 associated with a particular variable is exceeded, the processor 102 can dynamically change the snapshot interval 112. Initially, the apparatus 100 may be calibrated, or normalized, with an expected or baseline rate of data change and/or volume of data change. Then, the processor 102 may begin monitoring the rate of data changes and/or the volume of data changes. When neither the rate of data changes nor the volume of data changes exceeds a respective threshold 110, the processor 102 may select a user defined regular interval. For example, the user may set the regular interval to be every 10 minutes when the rate of data changes or the volume of data changes is below the respective thresholds 110.

At a later time, the processor 102 may detect that the rate of data changes has exceeded a respective threshold 110. In other words, a value of a variable associated with the data changes that is measured may exceed the respective threshold 110. For example, the data changes may be monitored to measure the rate of data changes. The respective threshold 110 may be 10 changes per second. The value of the rate of data changes may be measured to be 20 changes per second. Thus, the measured value for the variable of a rate of data changes may exceed the respective threshold of 10 changes per second.

When the rate of data changes has exceeded the respective threshold 110, the processor 102 may then set the snapshot interval 112 to a short time interval (e.g., every 5 minutes) associated with the rate of data changes increasing to take snapshots 114 more frequently. At a later time, the rate of data changes may fall below the respective threshold 110. The processor 102 may then set the snapshot interval 112 to the user defined regular time interval. At a later time, the volume of data changes may exceed a respective threshold 110. The processor 102 may then set the snapshot interval 112 to a short time interval (e.g., every 3 minutes) associated with the volume of data changes increasing to take snapshots 114 more frequently. At a later time, the volume of data changes may fall below the respective threshold 110. The processor 102 may then set the snapshot interval 112 back to the user defined regular time interval.

In some examples, each variable may have different thresholds 110 associated with different snapshots intervals 112. For example, when the rate of data change exceeds a first threshold, the snapshot interval may be set to 5 minutes. When the rate of data change exceeds a second threshold, the snapshot interval may be set to 1 minute. When the rate of data change exceeds a third interval time interval, the snapshot interval may be set to 30 seconds, and so forth. Although, the above example uses three different thresholds and three different snapshot intervals, it should be noted that each variable may have any number of thresholds and snapshot intervals.

The volume of data change variable may similarly have different thresholds 110 for different snapshot intervals 112. It should be noted that each variable may have a different number of thresholds and associated snapshot intervals or the same number of thresholds and associated snapshot intervals.

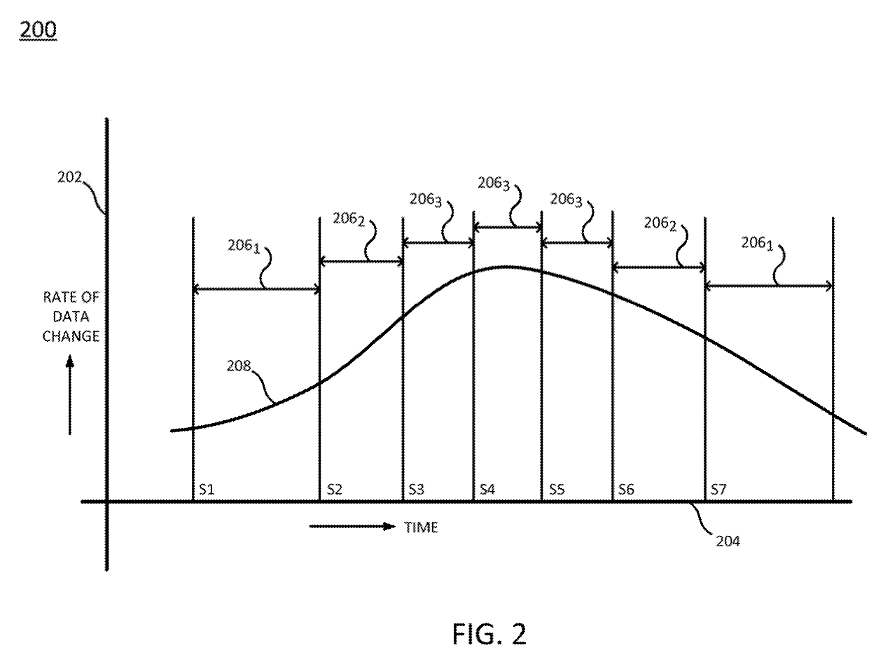

FIG. 2 illustrates an example graphical representation 200 of the different snapshot intervals 206₁, 206₂, and 206₃ taken between snapshots S1 to S7. The graphical representation 200 includes a rate of data change along a y-axis 202 and time moving from left to right on an x-axis 204. It should be noted that the graphical representation 200 may be similar for any variable that is monitored including a volume of data change, and so forth.

In one example, the graphical representation 200 illustrates a line 208 that charts the changes in the rate of data change. FIG. 2 illustrates a first snapshot S1 and a first snapshot interval 206₁ associated with the rate of data change that is below a threshold. At a later time a snapshot S2 is taken. At the time the snapshot S2 is taken, the rate of data change may exceed a first threshold and a snapshot interval 206₂ that is shorter than the snapshot interval 206₁ may be selected as shown by a shorter passing of time between snapshots S2 and S3 than compared to S1 and S2. At time the snapshot S3 is taken, the rate of data change may exceed a second threshold and a snapshot interval 206₃ that is shorter than the snapshot interval 206₂ may be selected.

The rate of data change may continue to exceed the second threshold and the snapshot interval 206₃ may be used for snapshots S4, S5, and S6. At a time the snapshot S6 is taken, the rate of data change may fall below the second threshold, but remain above the first threshold. As a result, the snapshot interval 206₂ may be selected for the snapshot S7. At the time the snapshot S7 is taken, the rate of data change may fall below the first threshold. Thus, the snapshot interval 206₁ may be selected for subsequent snapshots after the snapshot S7.

As can be seen by the graphical representation 200, when large amounts of data changes occur in a short amount of time, the apparatus 100 may be able to dynamically change the snapshot interval. As a result, more snapshots 114 can be captured during times of heavy data changes. More snapshots 114 may result in the apparatus 100 capturing more recovery points to provide a more precise recovery point should the apparatus 100 fail or another device associated with the data 108 fail.

In one example, as data changes occur less frequently than the expected rate of data changes calculated during an initial calibration, the snapshot intervals 112 may be increased. As a result, the processor 102 may take fewer snapshots during times of infrequent data changes to reduce the amount of irrelevant snapshots that are captured and reduce overall consumption of the memory 104.

Lastly, by dynamically changing the snapshot interval 112, each snapshot 114 may become more meaningful. In other words, since irrelevant snapshots may be eliminated, each snapshot 114 stored in memory 104 may be associated with some meaningful data changes in the data 108.

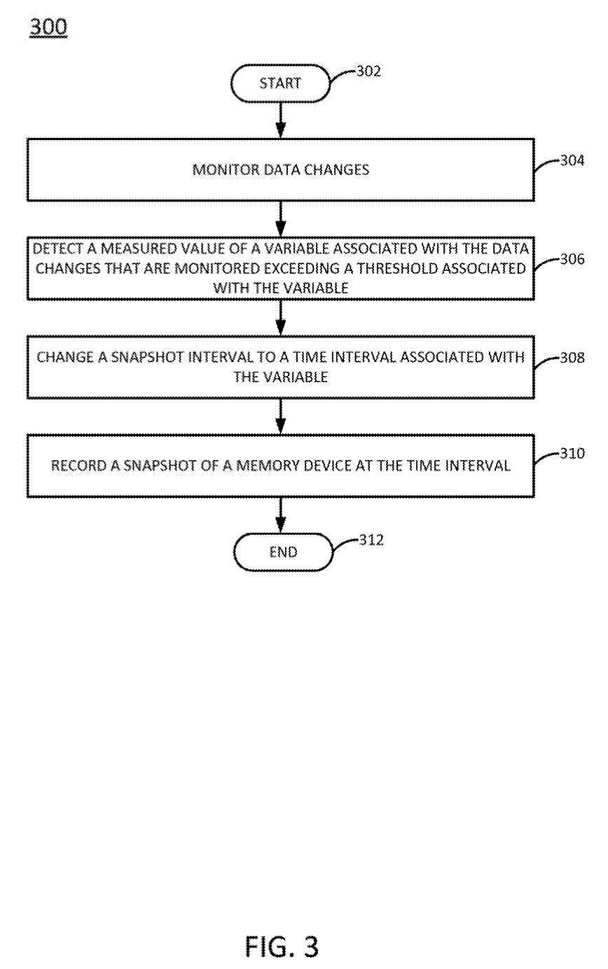

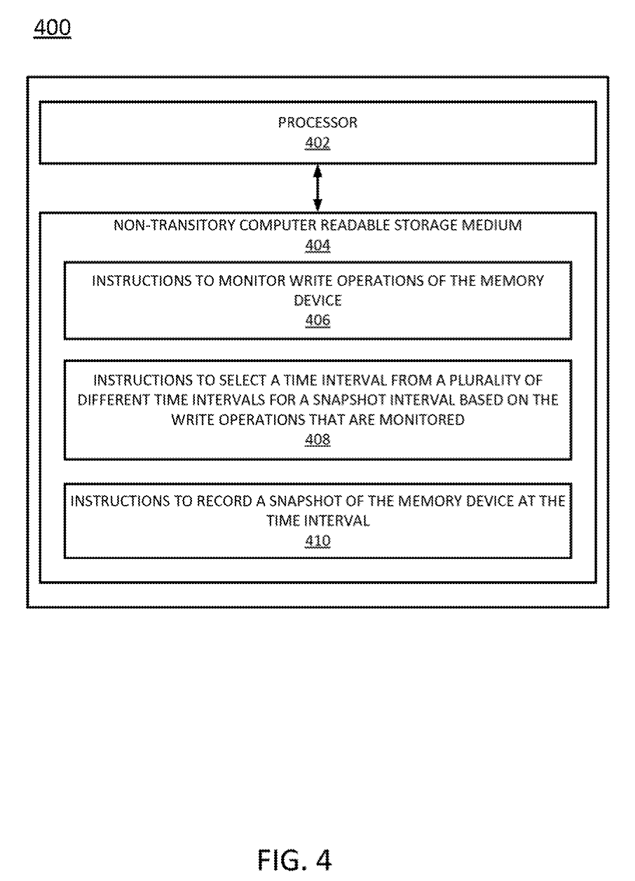

FIG. 3 illustrates a flow diagram of an example method 300 for changing snapshot intervals. In one example, the method 300 may be performed by a memory device (e.g., the apparatus 100) or the apparatus 400 illustrated in FIG. 4 and described below.

At block 302, the method 300 begins. At block 304, the method 300 monitors data changes. For example, the method 300 may monitor different variables associated with the data changes. The variables may include a rate of data changes, a volume of data changes, and the like. Data changes may refer to write operations to a memory or update requests.

In one example, an initial snapshot interval that is a user defined regular time interval may be set. For example, the initial snapshot interval may be based on an expected level of data changes for the variables that are measured.

At block 306, the method 300 detects a measured value of a variable associated with the data changes exceeding a threshold associated with the variable. As discussed above, each variable may have a respective threshold and associated snapshot interval. In one example, each variable may have multiple thresholds and different snapshot intervals associated with each threshold. Each variable may have the same number of thresholds and associated snapshot intervals, or a different number of thresholds and associated snapshot intervals.

At block 308, the method 300 changes a snapshot interval to a time interval associated with the variable. For example, if the rate of data change variable exceeded the respective threshold, the snapshot interval may be changed to the time interval associated with the rate of data change variable.

At block 310, the method 300 records a snapshot of the memory device at the time interval. For example, the snapshot may be taken after the amount of time associated with the snapshot interval has passed. For example, the amount of time may be determined based on a clock within the memory device.

In one example, the method 300 may be continuously repeated. For example, at a later time, the method 300 may detect that data changes exceeding a different respective threshold associated with a different variable. For example, at a later time, the method 300 may determine that the volume of data changes has exceeded a respective threshold.

As a result, the method 300 may change the snapshot interval to a new time interval associated with the different variable. The snapshot of the memory device may be captured at the new time interval. As the data changes are continuously monitored and the different thresholds associated with different variables are exceeded, or fall below the different thresholds, the snapshot interval may be changed or dynamically selected. At block 312, the method 300 ends.

FIG. 4 illustrates an example of an apparatus 400. In one example, the apparatus 400 may be the apparatus 100. In one example, the apparatus 400 may include a processor 402 and a non-transitory computer readable storage medium 404. The non-transitory computer readable storage medium 404 may include instructions 406, 408, and 410 that, when executed by the processor 402, cause the processor 402 to perform various functions.

In one example, the instructions 406 may include instructions to monitor write operations of the memory device. The instructions 408 may include instructions to select a time interval from a plurality of different time intervals for a snapshot interval based on the write operations that are monitored. The instructions 410 may include instructions to record a snapshot of the memory device at the time interval.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
monitoring, by a processor of a memory device, data changes;
detecting, by the processor, a measured value of a variable associated with the data changes that are monitored exceeding a threshold associated with the variable;
changing, by the processor, a snapshot interval to a time interval associated with the variable; and
recording, by the processor, a snapshot of the memory device at the time interval.

2. The method of claim 1, wherein the data changes comprise write operations in the memory device.

3. The method of claim 1, comprising:
setting, by the processor, an initial snapshot interval to a user defined regular time interval.

4. The method of claim 3, comprising:
detecting, by the processor, that the data changes fall below the respective threshold associated with the variable;
changing, by the processor, the snapshot interval the user defined regular time interval.

5. The method of claim 1, wherein the variable comprises at least one of: a rate of data change or a volume of data change.

6. The method of claim 1, wherein the variable is associated with a plurality of different thresholds.

7. The method of claim 6, wherein each one of the plurality of different thresholds is associated with a different time interval for the snapshot interval.

8. The method of claim 1, further comprising:
detecting, by the processor, the data changes exceeding a different respective threshold associated with a different variable of the plurality of variables;
changing, by the processor, the snapshot interval to a new time interval associated with the different variable; and
recording, by the processor, the snapshot of the memory device at the new time interval.

9. A non-transitory computer readable storage medium encoded with instructions executable by a processor of a memory device, the non-transitory computer-readable storage medium comprising:
instructions to monitor write operations of the memory device;
instructions to select a time interval from a plurality of different time intervals for a snapshot interval based on the write operations that are monitored; and
instructions to record a snapshot of the memory device at the time interval.

10. The non-transitory computer readable storage medium of claim 9, wherein the instructions to select comprise:
instructions to detect a measured value of a variable associated with the write operations that are monitored exceeding a threshold associated with the variable, wherein the time interval that is selected is the time interval associated with the variable.

11. The non-transitory computer readable storage medium of claim 10, wherein the variable comprises at least one of: a rate of data change or a volume of data change.

12. The non-transitory computer readable storage medium of claim 11, wherein the rate of data change comprises how frequently data is changed.

13. The non-transitory computer readable storage medium of claim 11, wherein the volume of data change comprises a total number of data changes.

14. The non-transitory computer readable storage medium of claim 11, wherein the plurality of different time intervals comprises a user defined regular time interval, a high rate of data change time interval, and a high volume of data change time interval.

15. The non-transitory computer readable storage medium of claim 9, further comprising:
instructions to select a different time interval from the plurality of different time intervals for the snapshot interval based on a change in a rate of the write operations that are monitored.

16. An apparatus, comprising:
a memory to store data;
a clock to track a snapshot interval; and
a processor communicatively coupled to the memory and the clock, the processor to monitor changes to the data, to detect a measured value of a variable associated with the changes to the data exceeding a threshold associated with the variable, to change the snapshot interval to a time interval associated with the variable, and to record a snapshot of the memory device at the time interval.

17. The apparatus of claim 16, comprising:
a second memory to store the snapshot.

18. The apparatus of claim 16, further comprising:
a communication interface to transmit the snapshot to a remotely located memory.

19. The apparatus of claim 16, wherein the processor is to select a different time interval from a plurality of different time intervals associated with different variables for the snapshot interval based on a change of the measured value of the variable that is monitored.

20. The apparatus of claim 16, wherein the processor is to select a different time interval from a plurality of different time intervals associated with different thresholds of the variable based on a change in the measured value of the variable that is monitored.
